(19) United States
(12) Patent Application Publication
(10) Pub. No.: US 2004/0249108 A1
(43) Pub. Date: Dec. 9, 2004

(54) Lightfast polyurethane clear lacquers

(76) Inventors: Bernd-Peter Dietrich, Monchengladbach (DE); Reinhard Halpaap, Odenthal (DE); Christoph Irle, Barcelona (ES); Meike Niesten, Koln (DE); Jorg Tillack, Bergisch Gladbach (DE)

Correspondence Address: BAYER MATERIAL SCIENCE LLC, 100 BAYER ROAD, PITTSBURGH, PA, 15205, US

(21) Appl. No.: 10/858,958

(22) Filed: Jun. 2, 2004

(30) Foreign Application Priority Data
Jun. 6, 2003 (DE) 10325669.5

(51) Int. Cl. C08G 18/00; C08G 18/38; C08G 18/32; C08G 18/40; C08G 18/28; C08G 18/77

(52) U.S. Cl. 528/85

(57) ABSTRACT

The invention provides novel solvent-free two-component polyurethane coating agents for preparing high quality yellowing-free coatings and a process for the preparation thereof. The coating agents include binder mixtures containing a polyisocyanate component with a viscosity at 23° C. of 2,000 to 150,000 mPas, a NCO content of 14 to 23 wt. % and a calculated mean NCO functionality of at least 2.8; a polyol component with a mean OH functionality <3, a viscosity at 23° C. of 5,000 to 150,000 mPas and a hydroxyl value of 400 to 700 mg KOH/g; and optionally one or more catalysts.

### CROSS REFERENCE TO RELATED PATENT APPLICATION

The present patent application claims the right of priority under 35 U.S.C. § 119 (a)-(d) of German Patent Application No.103 25669.5 filed Jun. 6, 2003.

### FIELD OF THE INVENTION

The invention provides novel solvent-free two-component polyurethane binder mixtures for preparing high quality yellowing-free coatings or moulded parts and a process for the preparation thereof.

### BACKGROUND OF THE INVENTION

Polyurethane systems (PUR systems) and the use thereof for preparing moulded parts and coatings are generally known and are described, for example, in Ullmann's Encyclopedia of Industrial Chemistry vol. A21, Polyurethanes, Dieterich, Uhlig, 1992 p. 665-716.

Due to problems associated with VOCs, solvent-free and emission-free PUR systems are of great interest because they can be cured after application largely without the emission of volatile constituents. In addition, substrates which are solvent-sensitive can be coated in this way. Solvent-free binder mixtures are in great demand in particular for high-build applications for ecological reasons, but also because complete emission of a solvent with the simultaneous formation of a homogeneous, bubble-free layer is not possible.

Solid moulded parts can be prepared by generally known processes such as manual casting or by the RIM (reaction injection moulding) process. So-called in-mould-coating (IMC) technology, where the coating components are applied to a mould corresponding to the object being coated and cured is of especial advantage for the preparation of coatings that are very thick. The surface gloss of the coated substrate can be improved, for example, by subsequent polishing. The great advantages of the IMC technique are rapid processing times and very low losses of raw materials.

Of particular importance for transparent coatings, e.g. in the vehicle construction industry or the furniture industry, are scratch-resistance, high gloss and a particularly low tendency for the binder to yellow. Lacquers with a glass transition temperature >70° C. are particularly advantageous here because they can be processed mechanically at a later stage, e.g. by polishing.

EP-A 0 943 637 and 0 978 523 describe transparent polyurethane coatings with a T_{g}>70° C. based on di- and/or polyisocyanates in combination with polyetherpolyols and/or polyesterpolyols and optionally low molecular weight multifunctional alcohols. In addition to that, the documents mentioned also disclose that the polyol component must have a mean hydroxyl functionality >3 in order to achieve a correspondingly high T_{g}. The disadvantage, however, is their sensitivity to yellowing, so they cannot be used as high quality lightfast substrate coatings.

EP-A 0 693 512 discloses the preparation of lightfast, abrasion-resistant and solvent-free polyurethane coatings by using mixtures of HDI polyisocyanates and isocyanurate polyisocyanates based on cycloaliphatic diisocyanates. Polyhydroxy compounds of the polyester, polyether, polycarbonate or polyestercarbonate type, as well as castor oil and its derivatives are disclosed as isocyanate-reactive components for cross-linking purposes.

Now, the object of the invention was the provision of a binder mixture which can be applied in a solvent-free manner and which leads to non-yellowing, post-polishable coatings of adequate hardness (T_{g}>70° C.).

### SUMMARY OF THE INVENTION

The present invention is directed to binder mixtures that contain:

A) a polyisocyanate component with a viscosity at 23° C. of 2,000 to 150,000 mPas, a NCO content of 14 to 23 wt. % and a calculated mean NCO functionality of at least 2.8, the polyisocyanate component including:

A1) 40 to 80 wt. % of one or more polyisocyanates based on hexamethylene diisocyanate (HDI polyisocyanates) with a NCO content of 16 to 24 wt. % and

A2) 20 to 60 wt. % of one or more polyisocyanates based on cycloaliphatic diisocyanates with a NCO content of 10 to 22 wt. %,

B) a polyol component with a mean OH functionality <3, a viscosity at 23° C. of 5,000 to 150,000 mPas and a hydroxyl value of 400 to 700 mg KOH/g the polyol component including:

B1) 50 to 80 wt. % of one or more polyesterpolyols based on aromatic carboxylic acids and containing no ether groups, with a mean OH functionality <3, a hydroxyl value of 200 to 500 mg KOH/g and a number average molecular weight of 200 to 900 g/mol, and

B2) 20 to 50 wt. % of one or more hydroxy-functional compounds which contain no ether groups and are different from the compounds in component B1), with a mean OH functionality of at least 1.8 and a number average molecular weight Mₙ of 32 to 1,000 g/mol, and

C) optionally one or more catalysts.

The present invention is also directed to coatings and coating compositions that contain the binder mixtures described above and one or more materials selected from the group consisting of surface-active substances, internal separating agents, fillers, colorants, pigments, flame retardants, hydrolysis prevention agents, microbicides, flow control agents, antioxidants and combinations thereof.

The present invention is further directed to substrates coated with the above-described coatings.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

It has now been found that mixtures of polyisocyanates based on hexamethylene diisocyanate (HDI) and polyisocyanates based on cycloaliphatic polyisocyanates in combination with polyol mixtures which contain no ether groups and have a mean OH functionality <3 based on low molecular weight polyhydroxy compounds and polyesterpolyols of aromatic carboxylic acids lead to particularly low-yellowing lacquer layers with a T_{g}>70° C.

The invention provides binder mixtures containing

A) a polyisocyanate component with a viscosity at 23° C. of 2,000 to 150,000 mPas, a NCO content of 14 to 23 wt. % and a calculated mean NCO functionality of at least 2.8,

containing

A1) 40 to 80 wt. % of one or more polyisocyanates based on hexamethylene diisocyanate (HDI) with a NCO content of 16 to 24 wt. % and

A2) 20 to 60 wt. % of one or more polyisocyanates based on cycloaliphatic diisocyanates with a NCO content of 10 to 22 wt. %,

B) a polyol component with a mean OH functionality <3, a viscosity at 23° C. of 5,000 to 150,000 mPas and a hydroxyl value of 400 to 700 mg KOH/g containing

B1) 50 to 80 wt. % of one or more polyesterpolyols based on aromatic carboxylic acids and containing no ether groups, with a mean OH functionality <3, a hydroxyl value of 200 to 500 mg KOH/g and a number average molecular weight of 200 to 900 g/mol, and

B2) 20 to 50 wt. % of one or more hydroxy-functional compounds which contain no ether groups and are different from the compounds in component B1), with a mean OH functionality of at least 1.8 and a number average molecular weight Mₙ of 32 to 1,000 g/mol,

C) optionally one or more catalysts

D) optionally auxiliary substances and/or additives.

The amounts of components A1) and A2) and of B1) and B2) respectively are preferably chosen so that they add up to 100 wt. %.

The invention also provides a process for preparing the binder mixtures according to the invention in which components A) to D) are mixed, optionally at elevated temperature, i.e., a temperature greater than ambient temperature.

The invention also provides use of the binder mixtures according to the invention to prepare moulded items and coatings.

Component A) preferably has a mean NCO functionality of 3 to 5.

The polyisocyanates A1) are polyisocyanates known per se which contain allophanate, biuret, isocyanurate, iminooxadiazinedione, oxadiazinetrione, uretdione and/or urethane groups, based on HDI and with a viscosity at 23° C. of 100 to 12,000 mPas, an isocyanate group content of 16 to 24 wt. % and a monomeric HDI content of less than 0.5 wt. %.

These are described, for example, in Laas et al., J. Prakt. Chem. 336, 1994, 185-200, EP-A 0 798 299 and DE-A 167 066 6.

The polyisocyanates in component A1) are preferably polyisocyanates based on HDI, of the type mentioned above, with uretdione, allophanate, isocyanurate and/or iminooxadiazinetrione structures which have a viscosity at 23° C. of 100 to 1,600 mPas and an isocyanate group content of 18 to 24 wt. %.

The polyisocyanates in component A1) are particularly preferably HDI polyisocyanates of the type mentioned above with isocyanurate and/or iminooxadiazinedione groups, with a viscosity at 23° C. of 300 to 1,400 mPas and with an isocyanate group content of 20 to 24 wt. %.

The polyisocyanates in component A2) are polyisocyanates known per se containing allophanate, biuret, isocyanurate, uretdione and/or urethane groups, based on cycloaliphatic diisocyanates with an isocyanate group content of 10 to 22 wt. % and a monomeric diisocyanate content of less than 0.5 wt. %, wherein, at 23° C., these polyisocyanates are present in the solid form or have a viscosity of more than 200,000 mPas. The following may be mentioned by way of example in this connection as cycloaliphatic diisocyanates: 1-isocyanato-3,3,5-trimethyl-5-isocyanatomethylcyclohexane (isophorone diisocyanate; IPDI), 2,4′- and 4,4′-diisocyanato-dicyclohexylmethane, 1,3- and 1,4-diisocyanatocyclohexane, 2(4)methyl-1,3-diisocyanatocyclohexane, 1,3- and 1,4-diisocyanato-methylcyclohexane, 1-isocyanato-1-methyl-4(3)-isocyanatomethylcyclohexane and any mixtures at all of these diisocyanates.

The polyisocyanates in component A2) are preferably compounds of the type just mentioned with isocyanurate groups which are known per se and are described, for example, in Laas et al., J. Prakt. Chem. 336, 1994, 185-200 and in the original literature mentioned therein.

The polyisocyanates in component A2) are particularly preferably those of the type just mentioned, based on IPDI and/or 2,4′- and 4,4′-diisocyanatodicyclohexylmethane, with an isocyanate group content of 13 to 19 wt. %.

The polyisocyanates in component A2) are very particularly preferably those of the type just mentioned, based on IPDI and with an isocyanate group content of 15 to 18 wt. %.

With regard to the parent isocyanate for components A1) and A2), it does not matter whether these have been prepared by a phosgene process or a phosgene-free process.

The polyol component B) has a mean OH functionality <3.0, preferably 2.0 to 2.5, a viscosity at 23° C. of 5,000 to 150,000 mPas, preferably 10,000 to 100,000 mPas, particularly preferably 10,000 to 70,000 mPas and a mean hydroxyl value of 400 to 700 mg KOH/g, preferably 450 to 650 mg KOH/g.

The polyesterpolyols with no ether groups in component B1), which are suitable as a constituent of polyol component B), are those with a mean OH functionality <3.0, preferably 2.0 to 2.5, with a hydroxyl value of 200 to 500 mg KOH/g, preferably 200 to 400 mg KOH/g and a number average molecular weight of 200 to 900 g/mol, preferably 200 to 750 g/mol, such as can be prepared in a known manner by reacting polyhydric alcohols with a molar deficiency of polybasic carboxylic acids, carboxylic anhydrides, lactones or polycarboxylic esters of low molecular weight C₁-C₄ alcohols.

To prepare the polyesterpolyols in component B1), one or more aromatic polybasic carboxylic acids or their anhydride, lactone or ester derivatives, optionally mixed with one or more aliphatic or cycloaliphatic polybasic carboxylic acids or their derivatives, are used. Particularly suitable are compounds with a number average molecular weight of 118 to 300 g/mol and a mean carboxyl functionality ≧2, such as, for example, succinic acid, adipic acid, sebacic acid, phthalic acid, isophthalic acid, terephthalic acid, trimellitic acid, phthalic anhydride, tetrahydrophthalic acid, maleic acid, maleic anhydride, dimethyl terephthalate or bis-glycol terephthalate or their anhydride, lactone or ester derivatives. Mixtures of adipic acid and isophthalic acid are preferred.

Polyhydric alcohols suitable for preparing these polyesterpolyols are preferably those with a number average molecular weight of 62 to 400 g/mol, such as, for example, 1,2-ethanediol, 1,2- and 1,3-propanediol, the isomeric butanediols, pentanediols, hexanediols, heptanediols and octanediols, 1,2- and 1,4-cyclohexanediol, 1,4-cyclohexane-dimethanol, 4,4′-(1-methylethylidene)-biscyclohexanol, 1,2,3-propanetriol, 1,1,1-trimethylolethane, 1,2,6-hexanetriol, 1,1,1-trimethylolpropane, 2,2-bis-(hydroxymethyl)-1,3-propanediol. 1,3-butanediol, neopentyl glycol and/or trimethylolpropane are preferred.

To prepare the polyesterpolyols, the polybasic carboxylic acids mentioned and/or their anhydride, lactone or ester derivatives, and polyhydric alcohols are polycondensed, catalyst-free or optionally in the presence of esterification catalysts, expediently in an atmosphere of an inert gas such as e.g. nitrogen, carbon dioxide, helium, argon, in the melt at temperatures of 150 to 220° C., preferably 180 to 220° C., optionally under reduced pressure, until the desired acid value, which is advantageously less than 10, preferably less than 5 mg KOH/g, is reached. Suitable esterification catalysts are, for example, iron, cadmium, cobalt, lead, zinc, antimony, magnesium, titanium and tin catalysts in the form of metals, metal oxides or metal salts. The polycondensation may also be performed, however, in the liquid phase in the presence of diluents and/or entraining agents, such as e.g. benzene, toluene, xylene or chlorobenzene, for the azeotropic removal by distillation of the condensation water.

Hydroxyfunctional component B2) which has no ether groups contains one or more hydroxy compounds which are different from the compounds in B1) and have a number average molecular weight of 32 to 1,000 g/mol, a mean OH functionality of at least 1.8, preferably 1.8 to 6.0. These are either low molecular weight monohydric or polyhydric alcohols or higher molecular weight polyols based on polyesters corresponding to the data given above.

For example, low molecular weight hydroxy compounds with a molecular weight of 32 to 350 g/mol such as 1,2-ethanediol, 1,2-propanediol, 1,3-butanediol, 1,2-, 1,3-, 1,4-, 2,3-, 1,5-pentanediol, 3-methyl-1,5-pentanediol, 1,6-hexandiol, 2-ethyl-1,3-hexanediol, 2-methyl-1,3-propanediol, 2,2-dimethyl-1,3-propanediol, 2-butyl-2-ethyl-1,3-propanediol, 2,2,4-trimethyl-1,3-pentanediol, 1,8-octanediol, higher molecular weight α,ω-alkanediols with 9 to 18 carbon atoms, cyclohexanedimethanol, cyclohexanediol, glycerine, trimethylolpropane, 1,2,4-butanedtriol, 1,2,6-hexanetriol, bis(trimethylolpropane), pentaerythritol, mannitol or methyl glycoside. Small amounts, but less preferably, of monohydric alcohols such as e.g. methanol, ethanol, propanol or butanol, may also be used.

Higher molecular weight polyester-based polyols in component B2) may be prepared, for example, from the low molecular weight alcohols mentioned under B1) using lactones such as e.g. ε-caprolactone, β-propiolactone, γ-butyrolactone, γ- and δ-valerolactone, 3,5,5- and 3,3,5-trimethylcaprolactone or any mixture of such lactones.

Preferred compounds for component B2) are trimethylolpropane, 2-butyl-2-ethyl-1,3-propanediol, 2,2,4-trimethyl-1,3-pentane-diol, cyclohexanedimethanol, 1,2-propanediol and/or 2,2-dimethyl-1,3-propanediol (neopentyl glycol), and any mixtures of these with each other.

Cyclohexanedimethanol, 1,2-propanediol and/or 2,2-dimethyl-1,3-propanediol and any mixture of these with each other are particularly preferred.

Very particularly preferred compounds for use as component B2) are mixtures of cyclohexanedimethanol and 1,2-propanediol.

It is expressly pointed out that the use of compounds which contain ether groups, such as e.g. polyalkylene oxides, polyetherpolyols, as a constituent of component B) is not within the scope of the present invention.

In binder mixtures according to the invention, components A) and B) are used in relative amounts such that the ratio of NCO to OH groups is 0.7 to 1.5, preferably 0.9 to 1.1, particularly preferably 1.0.

Catalysts C), which may optionally be used, may be compounds known per se from polyurethane chemistry for accelerating the NCO/OH reaction (see “Kunststoff Handbuch 7, Polyurethane” Carl-Hanser-Verlag, Munich—Vienna, 1984, p. 97-98).

These may be, for example: tertiary amines such as triethylamine, pyridine, methylpyridine, benzyldimethylamine, N,N-endoethylenepiperazine, N-methylpiperidine, pentamethyl-diethylenetriamine, N,N-dimethylaminocyclohexane, N,N′-dimethylpiperazine or metal salts such as iron(III) chloride, zinc chloride, zinc 2-ethylcaproate, tin(II) octoate, tin(II) ethylcaproate, tin(II) palmitate, dibutyltin(IV) dilaurate and molybdenum glycolate or any mixture of such catalysts. Tin compounds and tertiary amines are preferably used as compounds in component C).

The catalyst component C) is used, if at all, in amounts of 0.001 to 5 wt. %, preferably 0.01 to 1 wt. %, with respect to the amount of the individual components A) and B).

Optionally present auxiliary substances or additives D) may be e.g. surface-active substances, internal separating agents, fillers, colorants, pigments, flame retardants, hydrolysis prevention agents, microbicides, flow control agents, antioxidants such as 2,6-di-tert-butyl-4-methylphenol, UV absorbers of the 2-hydroxyphenyl-benzotriazole type or light stabilisers of the HALS compound type, substituted or not at the nitrogen atom, such as Tinuvin® 292 and Tinuvin® 770 DF (Ciba Spezialitäten GmbH, Lampertheim, Germany) or other commercial stabilisers such as are described for example in “Lichtschutzmittel fur Lacke” (A. Valet, Vincentz Verlag, Hanover, 1996 and “Stabilization of Polymeric Materials” (H. Zweifel, Springer Verlag, Berlin, 1997, Appendix 3, p. 181-213), or any mixture of these compounds.

In a preferred embodiment of the invention, the binder mixture according to the invention is prepared and optionally applied and optionally cured by the reaction injection moulding technique in closed moulds, e.g. to produce moulded items. It is also preferred in this connection not to use a closed mould for the technique mentioned above, wherein the ready-to-apply binder mixture is applied directly to suitable substrates, for example metal, glass, wood or plastics and cured, optionally under the effect of an elevated temperature. Following this, these cured coatings may optionally be post-processed by a mechanical process such as e.g. polishing.

Suitable substrates for coating with binder mixtures according to the invention are in particular metal, glass, wood or plastics. They are particularly suitable for coating interior parts in the vehicle construction industry, such as e.g. cladding for fascias, doors or other flat areas, steering wheels or the like which optionally have a high-grade wood veneer on one or more faces.

### EXAMPLES

All percentage data are understood to be percentages by weight (wt. %) unless stated differently.

The NCO content of the resins described in the examples and comparison examples was determined by titration in accordance with DIN 53 185.

The viscosities were determined at 23° C. using a rotational viscometer (speed 40 s⁻¹) (ViscoTester® 550, Thermo Haake GmbH, D-76227 Karlsruhe). The glass transition temperature T_{g} was determined by means of DSC (Differential Scanning Calorimetry) using a Mettler DSC 12E (Mettler Toledo GmbH, Giessen, Germany) at a rate of heating of 10° C./min.

Yellowing of the coatings produced was measured by applying the binder mixture to white lightfast support plates, using spreader frames and then firing at 100° C. for 5 min. The plates were then stored for 24 hours at 23° C. and then conditioned for 7 days at 90° C. The delta E value was measured before and after storing at elevated temperature, by means of CIELAB measurements according to DIN 6174 and DIN 6176 or ISO DIS 7724 part 3, as a measure of the yellowing.

### Example 1

Preparation of Polyisocyanates of Type A)

Polyisocyanate A1-I:

HDI polyisocyanate with isocyanurate groups A1-I was prepared in accordance with EP-A 330 966, example 11, wherein 2-ethylhexanol was used instead of 2-ethyl-1,3-hexanediol as the catalyst solvent. After separating off the excess monomeric HDIs by means of thin layer distillation an HDI polyisocyanate with a NCO content of 22.9%, a viscosity at 23° C. of 1,200 mPas and a mean NCO functionality of 3.1 (calculated from the NCO content and the number average molecular weight; determined by GPC measurement) was obtained.

Polyisocyanate A1-II:

4000 g (23.8 mol) of hexamethylene diisocyanate (HDI) were first heated to 60° C. in a 6 litre four-necked flask stirring apparatus with a reflux condenser, a metering device for the catalyst, an internal thermometer and a gas inlet and dissolved gases were removed by stirring for one hour at 20 mbar. Then the apparatus was aerated with nitrogen and the trimerisation process was started up, with stirring and the passage of a stream of nitrogen, by the portionwise addition of a 50 wt. % strength solution of tetrabutylphosphonium hydrogen difluoride, n-Bu₄P⁺[HF₂]⁻ in isopropanol/methanol (2:1), when the temperature increased by about 1-2° C. Progress of the reaction was followed by refractometric checking of the refractive index at 20° C. (n_{D(start)}=n_{D(HDI)}=1.4523 at 20° C.) using a GPR 11-37 from Index Instruments, UK. On achieving the desired NCO conversion (n_{D} ²⁰(stop)=1.4600), the reaction was terminated by adding 0.48 g of a 60 wt. % strength solution of p-toluenesulfonic acid in isopropanol per gram used of the catalyst solution mentioned above. The crude product obtained was worked up by thin layer distillation in a laboratory thin layer evaporator, of the short-path evaporator type, under a vacuum of 0.2 mbar and with temperatures of 130 and 150° C. in the heating medium in the pre-evaporator and main evaporator respectively. A polyisocyanate containing isocyanurate and iminooxadiazinedione groups with a NCO content of 23.7%, a viscosity of 65 mPas (23° C.), a HDI monomer content of less than 0.15% and a mean NCO functionality of 3.2 (calculated from the NCO content and the number average molecular weight; determined by GPC measurement) was obtained.

Polyisocyanate A2-I:

4000 g of IPDI were degassed under vacuum at 40° C. and, under an atmosphere of N₂, 25 g of a 5 wt. % strength solution of trimethylbenzylammonium hydroxide in n-butanol/methanol (9:1) were added in portions thereto and reacted at 70° C. until a NCO content of 30% was achieved. Reaction was terminated by adding 5 g of a 25 wt. % strength solution of dibutyl phosphate in IPDI and stirring was continued for another 1 hour at 60° C. Monomeric IPDI was then removed by distillation using a thin layer evaporator at 180-190° C. and 0.2 mbar, wherein 1,600 g of a solid resin with a NCO content of 16.7% and a mean NCO functionality of 3.3 (calculated from the NCO content and the number average molecular weight; determined by GPC measurement) was obtained.

Polyisocyanate A2-II:

2620 g of 4,4′-diisocyanatodicyclohexylmethane were trimerised at 60° C., down to a NCO content of 26.8%, using 6 g of a 10 wt. % strength solution of trimethylbenzylammonium hydroxide in 2-ethyl-hexanol:methanol (5:1). To terminate the trimerisation reaction, 0.5 g of bis-(2-ethylhexyl phosphate) were added. Then, 130 g of an isocyanurate polyisocyanate based on HDI, which was obtained in accordance with example 12 in EP-A 330 966, were added to the clear crude solution and monomeric 4,4′-diisocyanatodicyclohexylmethane was removed by thin layer distillation at 200° C. and 0.15 mbar. A pale, slightly yellowish solid resin with a NCO content of 15.1%, a melting point of 100° C., a monomeric diisocyanate content of <0.2% and a mean NCO functionality of 3.5 (calculated from the NCO content and the number average molecular weight; determined by GPC measurement) was obtained.

Polyisocyanates of Type A):

Solid polyisocyanates of type A2) based on cycloaliphatic diisocyanates were coarsely crushed and placed in a reaction vessel at room temperature under an atmosphere of N₂, along with the liquid HDI polyisocyanate of type A1). To dissolve the solid resin and homogenise the mixture, the whole was heated to 100-140° C. and stirred until a virtually clear solution was obtained. Then the mixture was cooled to 50° C. and filtered through a 200 μm filter.

The following polyisocyanates were prepared in this way.

Polyisocyanate A-I:

A mixture of 70 wt. % of the HDI trimer A1-I and 30 wt. % of the IPDI trimer A2-I, NCO content: 21.2%, viscosity at 23° C.: 20,000 mPas, NCO functionality: 3.2.

Polyisocyanate A-II:

A mixture of 60 wt. % of the HDI trimer A1-I and 40 wt. % of the IPDI trimer A2-I, NCO content: 20.3%, viscosity at 23° C.: 140,000 mPas, NCO functionality: 3.2.

Polyisocyanate A-III:

A mixture of 70 wt. % of the HDI trimer A1-II and 30 wt. % of the IPDI trimer A2-I, NCO content: 21.7%, viscosity at 23° C.: 12,100 mPas, NCO functionality: 3.2.

Polyisocyanate A-IV:

A mixture of 60 wt. % of the HDI trimer A1-II and 40 wt. % of the IPDI trimer A2-I, NCO content: 21.1%, viscosity at 23° C.: 46,000 mPas, NCO functionality: 3.2.

Polyisocyanate A-V:

A mixture of 70 wt. % of the HDI trimer A1-II and 30 wt. % of the dicyclohexylmethane trimer A2-II, NCO content: 20.8%, viscosity at 23° C.: 19,800 mPas, NCO functionality: 3.3.

Polyisocyanate A-VI:

A prepolymer of IPDI and a trimethylolpropane-started polypropylene oxide polyol, OH value 878 (polyether V250, Bayer AG, Leverkusen).

Over the course of 1 hour, with stirring at 80° C., 13 g of polyether V250 was grafted onto 87 g of IPDI, wherein the ratio of NCO to OH was 3.8. After finishing this addition, the reaction was completed at the same temperature for 2 hours, until the theoretical NCO content of 24.4% was achieved.

The prepolymer had a NCO content of 24.4%, a viscosity at 23° C. of 13,100 mPas and a free IPDI content of 11.7%.

Polyisocyanate A-VII:

A mixture of 70 wt. % of HDI-uretdione/trimer (prepared in accordance with example 2 in EP-A 0377177, NCO content 22.5%, viscosity at 23° C. 170 mPas, NCO functionality from GPC and NCO content: 2.5) and 30 wt. % of the IPDI trimer A2-I, NCO content 20.0%, viscosity at 23° C. 3,000 mPas, monomer content <0.5%, NCO functionality: 2.7.

### Example 2

Preparation of Polyols of the Type B)

Polyesters of type B1)

The reactants for polyester preparation, in accordance with the table given below, were weighed into a reactor which was fitted with a stirrer, heating, automatic temperature regulation, a nitrogen inlet, a column, a water separator and a storage vessel and heated to 200° C. with stirring and the passage of nitrogen in such a way that the temperature at the head of the column did not exceed 103° C. After completion of distillation of the theoretically calculated amount of reaction water, the water separator was replaced by a distillation bridge and the reaction mixture was stirred at 200° C. until the temperature at the head of the column had dropped to below 90° C. The column was removed and the product was further condensed down to an acid value of ≦5 mg KOH/g.

TABLE 1
Polyesters B1-I to B1-IV (data in parts by weight).

| Composition | B1-I | B1-II | B1-III | B1-IV |
|---|---|---|---|---|
| Trimethylolpropane | 20.55 | 19.02 | 19.57 | 19.44 |
| 1,3-butanediol | 24.90 | 23.05 | 23.71 | 23.55 |
| Neopentyl glycol | 14.82 | 13.80 | 14.11 | 14.02 |
| Adipic acid | 53.74 | 0 | 20.10 | 10.3 |
| Isophthalic acid | 0 | 56.35 | 35.00 | 45.00 |
| Reaction water | −13.3 | −12.22 | −12.49 | −12.31 |
| Characteristics: | | | | |
| Mean functionality | 2.7 | 2.7 | 2.7 | 2.7 |
| OH value (−) | 314 | 281 | 287 | 294 |
| Viscosity at 23° C. (mPas) | 4,000 | n.m. | n.m. | n.m. |

n.m.: not measurable, viscosity at room temp. too high (>300,000 mPas)

Preparation of Polyols of the Type B

Now, the previously prepared polyesters were mixed with alcohols (B2) at 100° C., in accordance with the following table, and stirring was continued at 100° C. for 2 hours.

TABLE 2
Polyols B-I to B-IV (data in parts by wt.)

| Composition | B-I | B-II | B-III | B-IV |
|---|---|---|---|---|
| Polyester B1-I | 53.9 | | | |
| Polyester B1-II | | 53.9 | | |
| Polyester B1-III | | | 66.9 | |
| Polyester B1-IV | | | | 66.9 |
| Trimethylolpropane | 9.2 | 9.2 | | |
| 2-butyl-2-ethyl-1,3- | 17.4 | 17.4 | | |
| propanediol | | | | |
| 2,2,4-trimethyl-1,3- | 19.5 | 19.5 | | |
| pentanediol | | | | |
| Cyclohexanedimethanol | | | 23.15 | 23.15 |
| 1,2-propanediol | | | 9.93 | 9.93 |
| Characteristics: | | | | |
| Mean functionality | 2.4 | 2.4 | 2.5 | 2.5 |
| OH value | 512 | 538 | 518 | 515 |
| Viscosity at 23° C. | 1,900 | 37,000 | 14,400 | 38,800 |
| (mPas) | | | | |

Polyol B-V

A polyol mixture with an OH value of 657 and a viscosity at 23° C. of 10,600 mPas, consisting of 50 wt. % of a trimethylolpropane-started polypropylene oxide polyol with an OH value of 878 and a viscosity at 23° C. of 6,100 mPas (polyether V 250, Bayer AG, Leverkusen), 25 wt. % of an ethylenediamine-started polypropylene oxide polyol with an OH value of 792 and a viscosity at 23° C. of 33,000 MPas (polyether E 810, Bayer AG, Leverkusen) and 25 wt. % of a polyester polyol based on adipic acid, diethylene glycol and trimethylolpropane with an OH value of 60, a mean OH functionality of 2.7 (Desmophen® 2015W, Bayer AG, Leverkusen).

Polyol B-VI

A polyester polyol which is solid at 23° C. based on phthalic anhydride, ethylene glycol and trimethylolpropane with an OH value of 386 and a mean functionality of 3.4.

Polyol B-VII

A polyester polyol with an OH value of 60 and a mean functionality of 2.7 based on adipic acid, diethylene glycol and trimethylolpropane, viscosity at 75° C. is 1,000 mPas (Desmophen® 2015W, Bayer AG, Leverkusen).

### Example 3

Coatings (According to the Invention)

100 ppm (with respect to the total formulation) of DBTL as catalyst were added to 100 g of the particular polyol of type B) with stirring. Then this polyol component, the polyisocyanate component of type A) and all the equipment required for application were heated to 50° C., before the two components were combined. The coating agent obtained in this way was applied to a glass plate using a 800 μm spreading frame and cured for 5 minutes at 100° C.

TABLE 3
Coating agents 3-1 to 3-7 (amounts in parts by wt.)

| | | | | | | | |
|---|---|---|---|---|---|---|---|
| Example | 3-1 | 3-2 | 3-3 | 3-4 | 3-5 | 3-6 | 3-7 |

| | | | | | | | |
|---|---|---|---|---|---|---|---|
| Polyol B-II | 100 | | | | | | |
| Polyol B-III | | 100 | 100 | | | 100 | 100 |
| Polyol B-IV | | | | 100 | 100 | | |
| Polyisocyanate A-I | 190 | 183 | | 182 | | | |
| Polyisocyanate A-II | | | 185 | | 184 | | |
| Polyisocyanate A-III | | | | | | 162 | |
| Polyisocyanate A-IV | | | | | | | 185 |
| DBTL (ppm) | 100 | 100 | 100 | 100 | 100 | 100 | 100 |
| T_{g} (° C.) | 75 | 76 | 86 | 78 | 81 | 71 | 81 |
| Yellow index after | 1.09 | 0.99 | 0.57 | 1.26 | 0.95 | 0.34 | 0.39 |
| storage, 7 d/90° C. | | | | | | | |
| Appearance | clear | clear | Clear | clear | clear | clear | clear |

Coatings 3-1 to 3-7 according to the invention are transparent and are characterised by a high T_{g} (>70° C.) and a smooth surface with a simultaneously very low tendency to yellow (ΔE<1.5).

### Example 4

Coatings (Comparison)

DBTL as catalyst was added to the particular polyol with stirring and the mixture was heated to 50° C. Then the polyisocyanate component, also heated to 50° C., was added with stirring. The coating agent obtained in this way was applied to a glass plate with a 800 μm spreading frame and cured at 100° C. for 5 minutes.

TABLE 4
Coating agents 4-1 to 4-5 (data in parts by wt.)

| Example | 4-1 | 4-2 | 4-3 | 4-4 | 4-5 |
|---|---|---|---|---|---|
| Polyol B-I | | | | | 100 |
| Polyol B-III | | | | 100 | |
| Polyol B-V | 100 | | | | |
| Polyol B-VI | | | 100 | | |
| Polyol B-VII | | 100 | | | |
| Polyisocyanate A-I | | 21.4 | 137 | | 183 |
| Polyisocyanate A-VI | 200 | | | | |
| Polyisocyanate A-VII | | | | 198 | |
| DBTL (ppm) | 100 | 100 | 100 | 100 | 100 |
| T_{g} (° C.) | 119 | n.m. | n.m. | 62 | 54 |
| Yellow index after storage, | 5.19 | <1.5 | <1.5 | <1.5 | <1.5 |
| 7 d/90° C. | | | | | |
| Appearance | clear | soft | cloudy | clear | clear |
| | | matt | | | |

n.m.: not measurable, coating is soft and does not have a measurable T_{g} above room temperature

Coatings according to comparison example 4-1 (reworking of example 3 from EP-A 0 943 637) have a relative high degree of yellowing, which means that the formulation is not suitable for preparing high quality yellowing-free coatings.

Coatings in example 4-2 based on the polyisocyanate to be used according to the invention with a polyesterpolyol based on aliphatic carboxylic acids with a mean OH functionality of 2.7 (polyol B-VII) lead to very soft and matt films.

Coatings according to comparison example 4-3 with a phthalic acid based polyester with a functionality of 3.4 lead to cloudy films when used with a polyisocyanate according to the invention.

Coatings according to comparison example 4-5 based on adipic acid with a mean functionality of 2.7 lead to too low a T_{g} of 54° C. when used with a polyisocyanate according to the invention.

Coatings according to comparison example 4-4 based on the adipic acid/isophthalic acid polyol according to the invention with a mean functionality of 2.7 lead to a low T_{g} of 62° C. when used with the polyisocyanate from EP 0 693 512 B1.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Binder mixtures comprising:
A) a polyisocyanate component with a viscosity at 23° C. of 2,000 to 150,000 mPas, a NCO content of 14 to 23 wt. % and a calculated mean NCO functionality of at least 2.8,
comprising:
A1) 40 to 80 wt. % of one or more polyisocyanates based on hexamethylene diisocyanate (HDI polyisocyanates) with a NCO content of 16 to 24 wt. % and
A2) 20 to 60 wt. % of one or more polyisocyanates based on cycloaliphatic diisocyanates with a NCO content of 10 to 22 wt. %,
B) a polyol component with a mean OH functionality <3, a viscosity at 23° C. of 5,000 to 150,000 mPas and a hydroxyl value of 400 to 700 mg KOH/g comprising:
B1) 50 to 80 wt. % of one or more polyesterpolyols based on aromatic carboxylic acids and containing no ether groups, with a mean OH functionality <3, a hydroxyl value of 200 to 500 mg KOH/g and a number average molecular weight of 200 to 900 g/mol, and
B2) 20 to 50 wt. % of one or more hydroxy-functional compounds which contain no ether groups and are different from the compounds in component B1), with a mean OH functionality of at least 1.8 and a number average molecular weight Mₙ of 32 to 1,000 g/mol, and
C) optionally one or more catalysts.

2. The binder mixture according to claim 1, wherein component A) has a mean NCO functionality of 3 to 5.

3. The binder mixture according to claim 1, wherein the HDI polyisocyanates contain isocyanurate groups and/or iminooxadiazinedione groups, have a viscosity at 23° C. of 300 to 1,400 mPas and have an isocyanate group content of 20 to 24 wt. %, are used in component A1).

4. The binder mixture according to claim 1, wherein polyisocyanates based on isocyanurate group-containing isophorone diisocyanate (IPDI) and/or 2,4′- and 4,4′-diisocyanato-dicyclohexylmethane with an isocyanate group content of 13 to 19 wt. % are used in component A2).

5. The binder mixture according to claim 1, wherein component B) has a mean OH functionality of 2.0 to 2.5, a viscosity at 23° C. of 10,000 to 70,000 mPas and a hydroxyl value of 450 to 650 mg KOH/g.

6. The binder mixture according to claim 1, wherein compounds with a mean OH functionality of 2.0 to 2.5, a hydroxyl value of 200 to 400 mg KOH/g and a number average molecular weight of 200 to 750 g/mol are used in component B1).

7. The binder mixture according to claim 1, wherein hydroxy-functional compounds with a number average molecular weight of 32 to 1,000 g/mol and a mean OH functionality of 1.8 to 6.0 are used in component B2).

8. A process for preparing binder mixtures according to claim 1, comprising mixing components A) to D), optionally at an elevated temperature.

9. Coatings and coating compositions comprising the binder mixtures in accordance with claim 1 and one or more materials selected from the group consisting of surface-active substances, internal separating agents, fillers, colorants, pigments, flame retardants, hydrolysis prevention agents, microbicides, flow control agents, antioxidants and combinations thereof.

10. Substrates coated with coatings in accordance with claim 9.

11. The binder mixture according to claim 1, further comprising one or more auxiliary substances and/or additives selected from the group consisting of surface-active substances, internal separating agents, fillers, colorants, pigments, flame retardants, hydrolysis prevention agents, microbicides, flow control agents, antioxidants and combinations thereof.
